(19) United States
(12) Patent Application Publication
(10) Pub. No.: US 2007/0004438 A1
(43) Pub. Date: Jan. 4, 2007

(54) Method and apparatus enabling PTT (push-to-talk) communications between legacy PSTN, cellular and wireless 3G terminals

(76) Inventors: Alec Brusilovsky, Naperville, IL (US); Vijay K. Gurbani, Lisle, IL (US)

Correspondence Address: CARMEN B. PATTI & ASSOCIATES, LLC, ONE NORTH LASALLE STREET, 44TH FLOOR, CHICAGO, IL, 60602, US

(21) Appl. No.: 11/174,168

(22) Filed: Jul. 1, 2005

(51) Int. Cl. H04B 7/00; H04Q 7/20

(52) U.S. Cl. 455/518

(57) ABSTRACT

An apparatus in one example has: a telecommunications network structured to allow simultaneous origination of simplex voice communication from one terminal of PTT (Push To Talk) terminals, wireline phone terminals, and multimedia web terminals to a predefined heterogeneous group of PTT terminals, wireline phone terminals, and a multimedia web terminals; and the telecommunications network structured to allow an originating terminal of the PTT terminals, wireline phone terminals, and a multimedia web terminals to receive simplex replies from other of the PTT terminals, wireline phone terminals, and multimedia web terminals.

### TECHNICAL FIELD

The invention relates generally to telecommunications networks, and more particularly to a telecommunications network that provides Push-To-Talk functionality.

### BACKGROUND

Wireless communication systems are constantly evolving. System designers are continually developing greater numbers of features for both service providers as well as for the end users. In the area of wireless phone systems, cellular based phone systems have advanced tremendously in recent years. Wireless phone systems are available based on a variety of modulation techniques and are capable of using a number of allocated frequency bands. Available modulation schemes include analog FM and digital modulation schemes using Time Division Multiple Access (TDMA) or Code Division Multiple Access (CDMA). Each scheme has inherent advantages and disadvantages relating to system architecture, frequency reuse, and communications quality. However, the features the manufacturer offers to the service provider and which the service provider offers to the consumer are similar between the different wireless systems.

Push-To-Talk, commonly abbreviated as PTT, is a method of conversing on half-duplex communication lines, including two-way radio, by pushing a button in order to send, allowing voice communication to be transmitted from you, and releasing to let voice communication be received.

PTT is one of the earliest mobile telephone protocols. It was the mobile equivalent of operator-assisted land telephone service. The protocol was as follows: The mobile telephone user pressed and held their PTT (Push-To-Talk) button for several seconds to get the mobile operator's attention. When they released the PTT button, an operator would reply (transmit on their channel) and ask them the number then wanted. The user would key up (PTT) and tell the operator the number they wished. The operator would dial and connect the land line, and the conversation would proceed. When there was no activity for awhile or the land line hung up, the operator could reuse the channel.

The term PTT has come to be more commonly known as referring to a feature that is available on certain more recent mobile phone models. It allows the mobile phone, when in a special mode, to function as a digital two-way radio in push-to-talk operation (in a fashion similar to the “trunking” feature of newer commercial and public-safety two-way radios). Only one person at a time can talk, by pressing a PTT button, and one or several others can listen instantly. The service connects mobile phone users with each other within seconds. Currently, PTT users have to belong to the same mobile operator's (carrier's) network in order to talk to one another. PTT commonly does not use up the regular airtime minutes that are available for general voice calls, but uses up a certain amount of special minutes that are used specifically for push to talk calls, or depending on one's billing plan, may be flat-rated. Regardless of the modulation scheme in use, the wireless phone available to the end user has a number of important features. Nearly all wireless phones incorporate at least a keyboard for entering numbers and text, and a display that allows the user to display text, dialed numbers, pictures and incoming caller numbers. Additionally, wireless phones may incorporate electronic phonebooks, speed dialing, single button voicemail access, and messaging capabilities, such as e-mail.

As described above, the PTT service is a cellular network service which works by a user pushing a button on a cellular phone and talking instantly walkie-talkie style with selected users who have similarly equipped phones with the equivalent service. Currently, PTT is a service provided on the cellular network only, and all the parties to the PTT conversation must have access to the cellular network through their cell phones.

There is a need in the prior art to overcome the present disadvantages of existing PTT and to extend the reach of PTT to wireline networks and multimedia-enabled Instant Messaging terminals.

### SUMMARY

The invention in one implementation encompasses an apparatus. The apparatus may comprise: a telecommunications network structured to allow simultaneous origination of simplex voice communication from one terminal of PTT (Push To Talk) terminals, wireline phone terminals, and multimedia web terminals to a predefined heterogeneous group of PTT terminals, wireline phone terminals, and a multimedia web terminals; and the telecommunications network structured to allow an originating terminal of the PTT terminals, wireline phone terminals, and a multimedia web terminals to receive simplex replies from other of the PTT terminals, wireline phone terminals, and multimedia web terminals.

The invention in another implementation encompasses an apparatus. The apparatus may comprise: a plurality of PTT (Push To Talk) terminals in a telecommunications network; at least one of a wireline phone and a multimedia web terminal in the telecommunications network; a respective interface for each of the at least one of a wireline phone and a multimedia web terminal; each of the plurality of PTT (Push To Talk) terminals being to be an originating terminal for a PTT session with at least one of PTT terminals, wireline phones, and multimedia web terminals; and each of the respective interfaces structured to allow a respective terminal of the at least one of a wireline phone and a multimedia web terminal to be an originating terminal for a PTT session with at least one of PTT terminals, wireline phones, and multimedia web terminals.

The invention in another implementation encompasses a method. This embodiment of the method may comprise: defining a plurality of PTT (Push To Talk) terminals in a group “B” in a telecommunications network; defining at least one of a PTT terminal, a wireline terminals and a multimedia web terminal in a group “A” in the telecommunications network; allowing a respective terminal of the PTT terminals in the group “B” to be an originating terminal for a PTT session with at least one of PTT terminals, wireline phones, and multimedia web terminals in either of the groups “A” and “B”; and allowing a respective terminal of the at least one of a PTT terminal, a wireline phone and a multimedia web terminal in the group “A” to be an originating terminal for a PTT session with at least one of PTT terminals, wireline phones, and multimedia web terminals in either of the groups “A” and “B”.

### DESCRIPTION OF THE DRAWINGS

Features of exemplary implementations of the invention will become apparent from the description, the claims, and the accompanying drawings in which:

FIG. 1 is a representation of one implementation of an apparatus in which a telecommunications network provides Push-To-Talk functionality;

FIG. 2 is a more detailed representation of a portion of the FIG. 1 embodiment; and

FIG. 3 is a representation of one exemplary flow diagram for providing Push-To-Talk functionality in a telecommunications network.

### DETAILED DESCRIPTION

One example of how Push-To-Talk operates is as follows. First, the user selects the people he or she wants to talk to from a list. At the push of a button, all of these previously defined addressees immediately receive an invitation which they can accept or decline. As soon as the participants have confirmed, the initial caller pushes an appropriate button and starts the chat, which everyone hears simultaneously. There is no time-consuming call setup, because the “Always On” feature of the network maintains the connection all along. Any group member can reply immediately by pressing the appropriate button. The communication can only go in one direction at a time, however: whoever presses the button first, talks first.

Push-To-Talk is therefore similar to traditional voice radio, although the new service can do much more. Since it runs over mobile networks, it can be used anywhere, even internationally. Push-To-Talk calls can be heard only by the registered members of a group call, which is a clear benefit in terms of security.

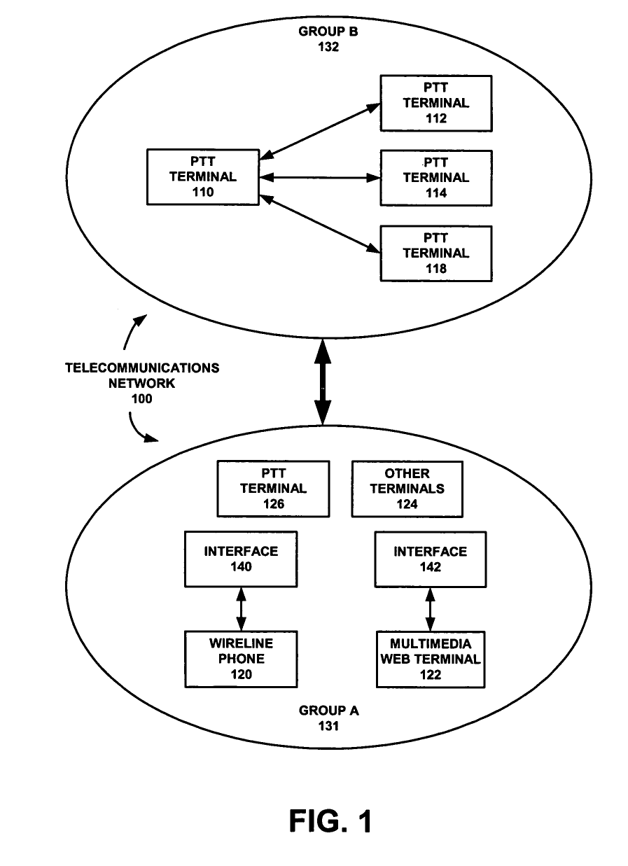

FIG. 1 is a representation of one implementation of an apparatus in which a telecommunications network 100 provides Push-To-Talk functionality. One embodiment of the present method and apparatus may have a plurality of PTT (Push To Talk) terminals 110, 112, 114, 118 in the telecommunications network 100. At least one of a wireline phone 120, a multimedia web terminal 122, as well as other types of terminals 124 in the telecommunications network 100. a respective interface for each of the at least one of a wireline phone and a multimedia web terminal. Each of the plurality of PTT (Push To Talk) terminals 110, 112, 114, and 118 may be an originating terminal for a PTT session with at least one of PTT terminals 110, 112, 114, and 118, which are located in a group B 132, and wireline terminal 120, multimedia web terminal 122, further PTT terminal 126, and other types of terminals 124, which are located in a group A 131.

Each of respective interfaces 140, 142 may be structured to allow a respective terminal of the at least one of a wireline phone 120 and a multimedia web terminal 122 to be an originating terminal for a PTT session with at least one of PTT terminals (such as 110, 112, 114, 118, 126) wireline phones 120, multimedia web terminals 122, and other terminals 124.

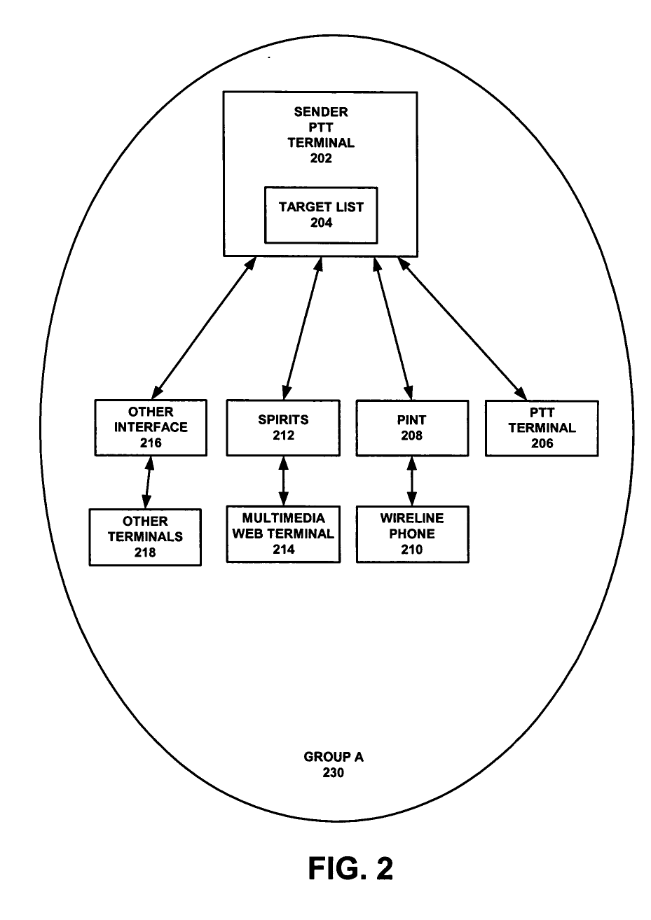

FIG. 2 is a more detailed representation of a portion of the FIG. 1 embodiment. The interface 208 for the wireline phone 210 may be a PINT (PSTN Internet Interworking, IETF RFC 2848) that is a SIP-based protocol that allows control of PSTN from an Internet host. SIP (Session Initiation Protocol, IETF RFC 3261) is a ASCI-based protocol that allows to start, control and terminate multimedia (i.e., voice, video, text, IM, etc.) sessions. SIP is utilizing SDP (Session Description Protocol) for media/codec description and negotiations between SIP end points and RTP (Realtime Transport Protocol) for media transport.

The interface 212 for the multimedia web terminal 214 may be a SPIRITS (Services in the PSTN/IN Requesting InTernet Services) interface. The SPIRITS interface 212 is a SIP-based protocol that extracts event notifications from a PSTN network and relays the event notifications to the Internet. There may be other interfaces 216 for other terminals 218. In this system, an interface is not needed for the PTT terminal 206.

Any of the terminals 202, 206,210, 214, 218 may originate a PTT session with any or all of these different terminal types. In the FIG. 2 embodiment the Sender PTT terminal 202, for example, forms a target list 204 of terminals that are desired to be part of a PTT session. The sender PTT terminal 202 sends invitations to each of the terminals 206, 210, 214, 218 which may or may not join the PTT session.

The following two cases are just two examples of the operation of embodiments of the present method and apparatus.

Case 1: Devices in Group B originate a PTT to devices in Group A.

Under the customary operations of PTT, a cellular phone user (the “sender”) creates a target list of selected recipients of the PTT. Normally, the target list would contain users who have similarly equipped cellular phones capable of receiving (and originating the PTT). According to embodiments of the present method and apparatus, this target list may also contain POTS numbers and the Web address (called a URI, Universal Resource Identifier) of a user using a multi-media device attached to the Internet. The URI may be an electronic mail-like URI, or it may be a phone number of a device accessible over the Internet.

When the sender sends a PTT, it is delivered normally to all receivers in the target list that have PTT equipped cellular phones. In addition, the PTT is also delivered to a PINT system with instructions to call a wireline station. The PINT system subsequently places a call to the recipient of the POTS phone, and upon answer, will play out the PTT message. Should the recipient of the POTS phone want to become a party to the PTT conversation until the conversation ends, the recipient of the POTS phone may dial a specialized code that will execute service logic in a PSTN/IN entity. This service logic will cause the recipient of the POTS phone to become a member of the PTT group for the duration that the PTT session is in progress; the user may press the “#” key (for example) to request the floor, if needed.

Another possibility is that the target list contains URIs. The PTT will be delivered to URIs using the SPIRITS protocol. For receiving a discrete PTT message, the SIP NOTIFY message may include the PTT as an attachment. Alternatively, to participate in a PTT session until it ends, the SPIRITS notifier may extend a SIP INVITE to the URI, thus allowing the Internet device to participate in the ongoing PTT session. Depending on the capabilities of the Internet device (e.g. computer, PDA, Internet phone), appropriate mechanisms will be used to request the floor.

Case 2: Devices in Group A originate a PTT to devices in Group B (or even other devices in Group A).

As a prerequisite, all devices in Group A will have pre-configured a target list containing cellular users as well as other devices in Group A who will receive a PTT originated by the device in Group A. If the device in Group A is a POTS phone, then to send a PTT, the following steps will be undertaken:

1: The user of the POTS phone dials an access number (possibly a toll-free number) to start the PTT service.

2: The PTT service authenticates the user of the POTS phone and identifies the PTT group to send the PTT to a POTS user that may be a part of multiple PTT groups.

3: Once the PTT group has been identified, the POTS user speaks into the POTS phone and either hangs up to send the PTT, or presses the “#” key to send that particular PTT and remain connected for a subsequent PTT session.

4: The PTT service then sends the PTT to cellular users in the target list (for devices in the target list that are in Group A, the discussion of “Case 1” will be followed to deliver the PTT.

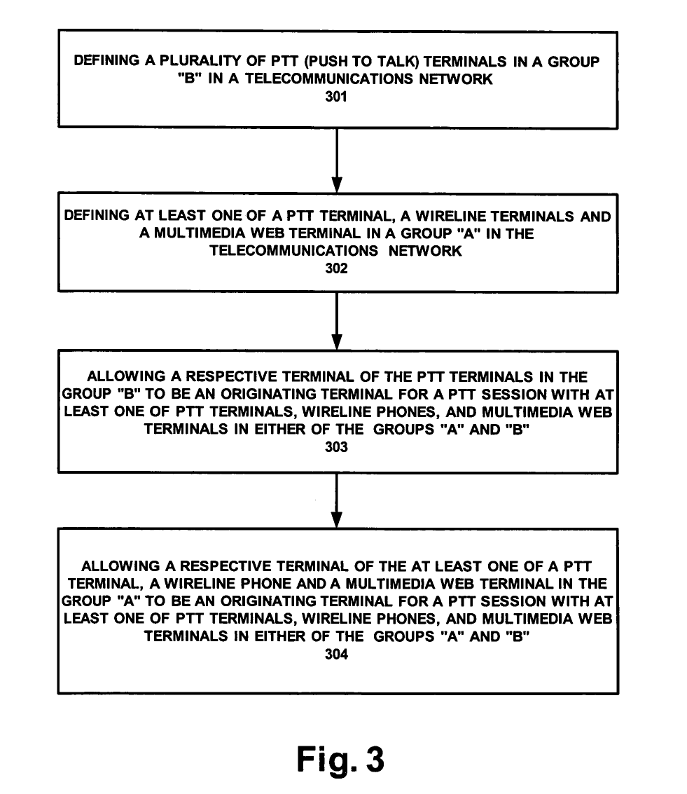

FIG. 3 is a representation of one exemplary flow diagram of the present method. This method may have the steps of: defining a plurality of PTT (Push To Talk) terminals in a group “B” in a telecommunications network (301); defining at least one of a PTT terminal, a wireline terminals and a multimedia web terminal in a group “A” in the telecommunications network (302); allowing a respective terminal of the PTT terminals in the group “B” to be an originating terminal for a PTT session with at least one of PTT terminals, wireline phones, and multimedia web terminals in either of the groups “A” and “B” (303); and allowing a respective terminal of the at least one of a PTT terminal, a wireline phone and a multimedia web terminal in the group “A” to be an originating terminal for a PTT session with at least one of PTT terminals, wireline phones, and multimedia web terminals in either of the groups “A” and “B” (304).

The present apparatus in one example may comprise a plurality of components such as one or more of electronic components, hardware components, and computer software components. A number of such components may be combined or divided in the apparatus.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

We claim:

1. An apparatus comprising:
a telecommunications network structured to allow simultaneous origination of simplex voice communication from one terminal of PTT (Push To Talk) terminals, wireline phone terminals, and multimedia web terminals to a predefined heterogeneous group of PTT terminals, wireline phone terminals, and a multimedia web terminals; and
the telecommunications network structured to allow an originating terminal of the PTT terminals, wireline phone terminals, and a multimedia web terminals to receive simplex replies from other of the PTT terminals, wireline phone terminals, and multimedia web terminals.

2. The apparatus according to claim 1, wherein the wireline phone has a PINT (PSTN Internet Interworking) interface.

3. The apparatus according to claim 2, wherein the PINT interface is a SIP-based protocol that allows control of PSTN from an Internet host.

4. The apparatus according to claim 1, wherein the multimedia web terminal has a SPIRITS (Services in the PSTN/IN Requesting InTernet Services) interface.

5. The apparatus according to claim 4, wherein the SPIRIUTS interface is a SIP-based protocol that extracts event notifications from the PSTN network and relays the event notifications to the Internet.

6. The apparatus according to claim 1, wherein the telecommunications network has a plurality of PTT terminals in a group “B”.

7. The apparatus according to claim 1, wherein the telecommunications network has a plurality of at least wireline phones and multimedia web terminals in a group “A”.

8. The apparatus according to claim 7, wherein the group “A” further contains at least one PTT terminal.

9. An apparatus comprising:
a plurality of PTT (Push To Talk) terminals in a telecommunications network;
at least one of a wireline phone and a multimedia web terminal in the telecommunications network;
a respective interface for each of the at least one of a wireline phone and a multimedia web terminal;
each of the plurality of PTT terminals being to be an originating terminal for a PTT session with at least one of PTT terminals, wireline phones, and multimedia web terminals; and
each of the respective interfaces structured to allow a respective terminal of the at least one of a wireline phone and a multimedia web terminal to be an originating terminal for a PTT session with at least one of PTT terminals, wireline phones, and multimedia web terminals.

10. The apparatus according to claim 10, wherein the interface of the wireline phone is a PINT (PSTN Internet Interworking) interface.

11. The apparatus according to claim 10, wherein the PINT interface is a SIP-based protocol that allows control of PSTN from an Internet host.

12. The apparatus according to claim 10, wherein the interface of the multimedia web terminal is a SPIRITS (Services in the PSTN/IN Requesting InTernet Services) interface.

13. The apparatus according to claim 10, wherein the SPIRITS interface is a SIP-based protocol that extracts event notifications from the PSTN network and relays the event notifications to the Internet.

14. The apparatus according to claim 10, wherein the plurality of PTT (Push To Talk) terminals are in a group “B”.

15. The apparatus according to claim 10, wherein the at least one of a wireline phone and a multimedia web terminal are in a group “A”.

16. The apparatus according to claim 10, wherein the group “A” further contains at least one PTT (Push To Talk) terminal.

17. A method comprising:
defining a plurality of PTT (Push To Talk) terminals in a group “B” in a telecommunications network;
defining at least one of a PTT terminal, a wireline terminals and a multimedia web terminal in a group “A” in the telecommunications network;
allowing a respective terminal of the PTT terminals in the group “B” to be an originating terminal for a PTT session with at least one of PTT terminals, wireline phones, and multimedia web terminals in either of the groups “A” and “B”; and
allowing a respective terminal of the at least one of a PTT terminal, a wireline phone and a multimedia web terminal in the group “A” to be an originating terminal for a PTT session with at least one of PTT terminals, wireline phones, and multimedia web terminals in either of the groups “A” and “B”.

18. The method according to claim 17, wherein the method further comprises:
creating, by a respective terminal in one of the groups “A” and “B”, a target list that contains at least one of the terminals in the group “B” and in the group “A”.

19. The method according to claim 18, wherein the target list contains telephone numbers for wireline terminals, URI (Universal Resource Identifiers) for multimedia web terminals, and identifiers for PTT terminals.

20. The method according to claim 17, wherein the method further comprises:
dialing, from a wireline terminal, an access number to start a PTT session;
authenticating the wireline terminal and identifying one of the groups “A” and “B” to which send an initiation; and
hanging up a receiver of the wireline terminal to send a PFF response, or pressing a key on the wireline terminal to send a PFF response and remaining connected for the PTT session.
